(19) United States
(12) Patent Application Publication
(10) Pub. No.: US 2005/0150344 A1
(43) Pub. Date: Jul. 14, 2005

(54) Machine for cutting parts of a window blind

(76) Inventors: Ming Nien, Changhua Hsien (TW); Wen-Yeu Lee, Taichung (TW)

Correspondence Address: BIRCH STEWART KOLASCH & BIRCH, PO BOX 747, FALLS CHURCH, VA, 22040-0747, US

(21) Appl. No.: 10/896,942

(22) Filed: Jul. 23, 2004

(30) Foreign Application Priority Data
Jan. 14, 2004 (TW) 093200689

(51) Int. Cl. B26D 1/00

(52) U.S. Cl. 83/651

(57) ABSTRACT

A machine for cutting parts of a window blind includes a machine base and two cutting units mounted respectively on the machine base. Each cutting unit includes two locating holes for insertion of the parts of the window blind, two cutters movable relative to the locating holes, a clutch for connecting and disconnecting the cutters, and a driving mechanism. The driving mechanism drives the cutters to move synchronously to cut off the parts of the window blind that extend out of the locating holes when the cutters are connected by the clutch. The driving mechanism drives only one of the cutters to move to cut off the parts of the window blind that extend out of one of the locating holes when the cutters are disconnected.

### BACKGROUND OF THE INVENTION

1. Field of the Invention

The present invention relates generally to window blinds and more specifically, to a cutting machine for cutting parts of a window blind subject to the desired length.

2. Description of the Related Art

Window blind manufacturers provide only a limited number of sizes for each model, and the retailers or upholsterers cut the window blinds to the desired sizes by means of a window blind cutting machine when selling or installing the window blinds.

The parts of a window blind are generally comprised of a headrail, a set of slats, and a bottom rail. These window blind parts may be made of different materials. For example, the headrail may be made of hard metal, and the slats may be made of aluminum, PVC (polyvinyl chloride), compound material, or wood. Commonly, the bottom rail and the slats are made of same material. Cutting different materials of window blind parts at a time may cause window blind parts to have a different shape of cutting edge. In order to produce a good cutting edge at each window blind part, die cutting is sued to cut metal headrail, and slats made of aluminum, PVC or compound material are preferably cut by another die cutting method other than the die cutting used for cutting the metal headrail. In addition, saw cutting is preferably employed to cut slats that are made of wood.

A conventional window blind cutting machine uses a single die cutter to cut window blind parts. However, as stated above, this window blind cutting machine cannot produce a good cutting edge at each window blind part. Therefore, window blind cutting machines with two die cutters are developed. U.S. Pat. No. 6,196,099 discloses a similar design. According to this patent, the cutters may be respectively driven by different drive sources (see FIGS. 2, 7, and 15 of the disclosure), or driven by a common drive source (see FIG. 8 of the disclosure). When two drive sources are used (see FIGS. 2, 7, and 15 of the disclosure), the cost is relatively increased, and the operation procedure is complicated. When a common drive source is used (see FIG. 8 of the disclosure), the machine is not practical for cutting a window blind having a metal headrail and wooden slats. Using a window blind cutting machine having multiple cutters to be driven by a common drive source to cut the headrail, the slats will be cut, producing an uneven cut edge at each window blind part.

Further, because the structure of a window blind is symmetrical, it is necessary to cut one end of the window blind at one half of the total length to be cut off, and then to cut the other end of the window blind at one half of the total length to be cut off so that the structure of the well-cut window blind is maintained symmetrical. Using the aforesaid conventional window blind cutting machines to cut the two ends of the window blind requires much labor since the other end of the window blind to be cut off will be manually set in position for cutting after the one end of the window blind has been cut.

Therefore, it is desirable to provide a window blind cutting machine that eliminates the drawbacks of the aforesaid various conventional designs.

### SUMMARY OF THE INVENTION

The present invention has been accomplished under the circumstances in view. It is the primary objective of the present invention to provide a window blind cutting machine, which enables the parts of the window blind made of various materials to be selectively cut.

It is another objective of the present invention to provide a window blind cutting machine, which enhances the cutting effect and simplifies the cutting process by employing two cutters at two ends of the cutting machine for cutting two ends of the window blind.

It is still another objective to provide a window blind cutting machine, which has an automatically cutting effect.

To achieve these objectives of the present invention, the machine for cutting parts of a window blind provided by the present invention comprises an elongated machine base for carrying thereon the parts of the window blind, which are parallel to and movable along a longitudinal axis of the machine base, and two cutting units mounted on two ends of the machine base. Each cutting unit comprises a first locating hole and a second locating hole for insertion of the parts of the window blind, a first cutter and a second cutter movable relative to the first and second locating holes respectively, a clutch for connecting and disconnecting the second cutter to the first cutter, and a driving mechanism for driving synchronously the first cutter and the second cutter to move across the first locating hole and the second locating hole respectively so as to cut off the parts of the window blind that extend out of the first locating hole and the second locating hole when the second cutter is connected to the first cutter by the clutch, and for driving the first cutter to move across the first locating hole so as to cut off the parts of the window blind that extend out of the first locating hole when the second cutter is disconnected to the first cutter.

### BRIEF DESCRIPTION OF THE DRAWINGS

FIG. 1 is a perspective view of a window blind cutting machine according to the present invention.

FIG. 2 is another perspective view of the present invention when viewed from another angle.

FIG. 3 is an exploded view of a part of the present invention, showing the structure of the first cutting unit.

FIG. 4 is a perspective view of a part of the present invention, showing the arrangement of the first cutting unit and the first measuring unit on the machine base.

FIG. 5 is a perspective view of a part of the present invention, showing the status of the first cutter in an initial position.

FIG. 6 is a perspective view of a part of the present invention, showing the status of the first cutter in a cut-off position.

FIG. 7 is a perspective view of a part of the present invention, showing the first cutter moved to the cut-off position and the second cutter moved with the first cutter.

### DETAILED DESCRIPTION OF THE INVENTION

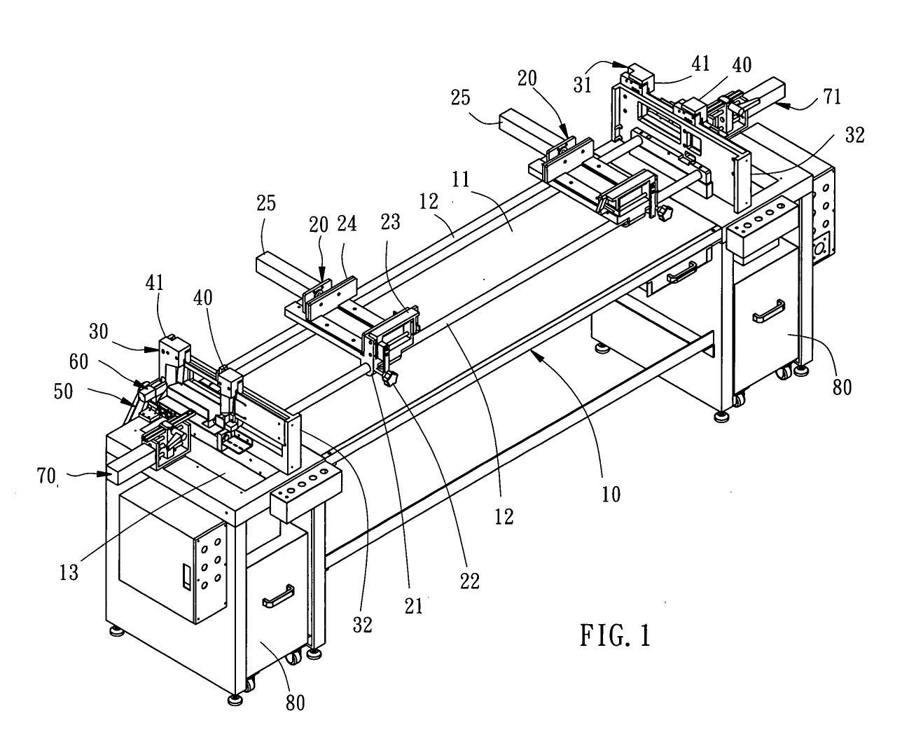

Referring to FIGS. 1-4, a window blind cutting machine is shown comprising an elongated machine base 10, a first cutting unit 30 and a second cutting unit 31 disposed near the two distal ends of the machine base 10 at the top, two clamping seats 20 mounted on the machine base 10 and respectively slidable on the machine base 10 between the first cutting unit 30 and the second cutting unit 31, a first measuring unit 70 and a second measuring unit 71 respectively disposed at the two distal ends of the machine base 10 adjacent to the cutting units 30 and 31 at an outer side, and two dust baskets 80 respectively mounted in the machine base 10 below the cutting units 30 and 31.

The machine base 10 has an elongated worktable 11, two guiding rods 12 longitudinally arranged in parallel on the worktable 11, and two top openings 13 disposed near the two distal ends thereof and adapted to guide waste chips to the dust baskets 80 that are respectively disposed below the two top openings 13.

The clamping seats 20 are mounted on and respectively movable along the guiding rods 12, each including a bottom coupling block 21 sleeved onto one guiding rod 12, a lock screw 22 threaded into the bottom coupling block 21 and perpendicularly stoppable against the respective guiding rod 12 for locking the respective clamping seat 20 in a desired position, a fixed clamping plate 23 and a movable clamping plate 24 vertically parallel disposed at the top side, and a pneumatic cylinder 25 having an output rod connected to the movable clamping plate 24 for moving the movable clamping plate 24 toward or away from the fixed clamping plate 23 so as to further adjust the pitch between the fixed clamping plate 23 and the movable clamping plate 24 subject to the workpiece (parts of a window blind) to be cut. After loading of the workpiece (parts of a window blind) on the clamping seats 20, the movable clamping plates 24 of the clamping seats 20 are respectively adjusted to hold down the loaded workpiece against the respective fixed clamping plates 23, and then the clamping seats 20 are moved along the guiding rods 12 to feed the loaded workpiece for cutting by the first cutting unit 30 or the second cutting unit 31.

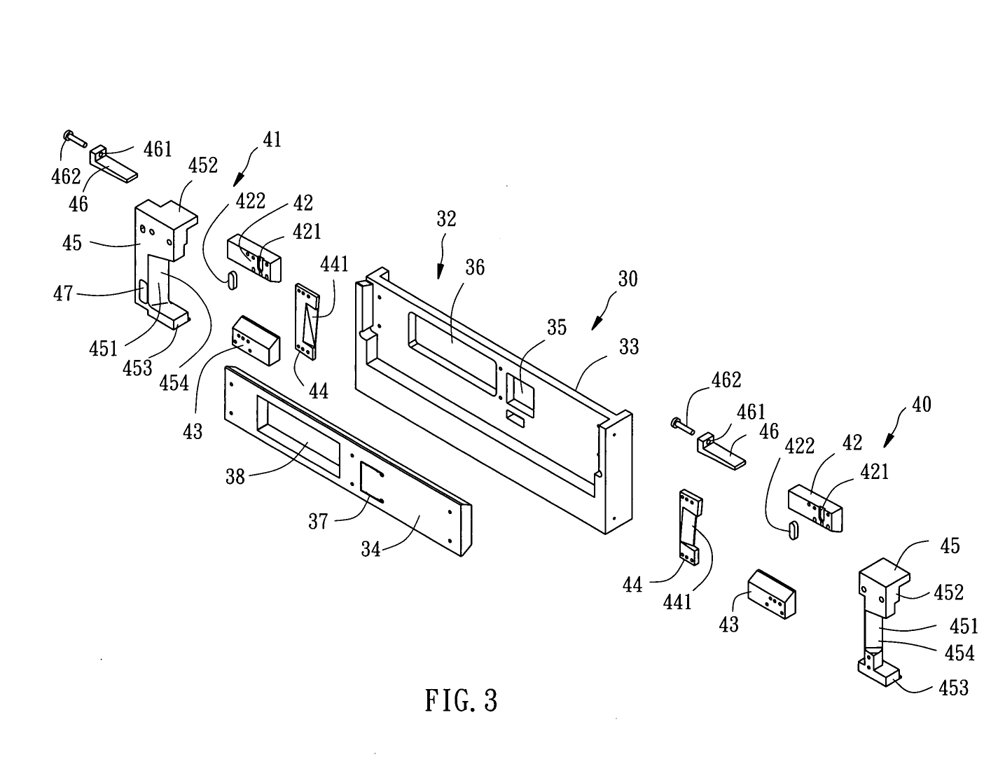

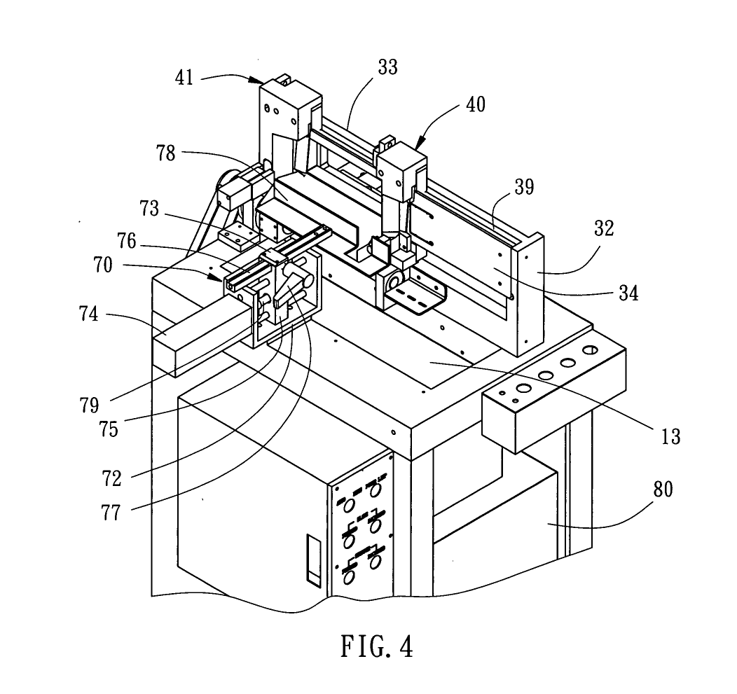

The cutting units 30 and 31 are mounted on the worktable 11 near the two distal ends of the worktable 11, each comprising a cutter holder 32, a first cutter 40, a second cutter 41, a driving mechanism 50, and a clutch 60. The cutter holder 32 is substantially elongated and flat and is vertically mounted on the worktable 11 of the machine base 10 in transverse direction (perpendicular to the extending direction of the guiding rods 12). As shown in FIG. 3, the cutter holder 32 comprises a first board 33 and a second board 34. The first board 33 is disposed at an inner side facing the clamping seats 20. The second board 34 is disposed at an outer side remote from the clamping seats 20. The first board 33 has a first opening 35 and a second opening 36. The first opening 35 is a square opening near the front side of the machine base 10. The second opening 36 is a rectangular opening near the rear side of the machine base 10. The second board 34 has a first locating hole 37 and a second locating hole 38 respectively disposed corresponding in location to the first opening 35 and the second opening 36. According to the present embodiment, the first locating hole 37 has a shape similar to the profile of the headrail of the window blind to be cut, and is adapted to receive the headrail for cutting. The second locating hole 38 and the second opening 36 are same in shape, and adapted to receive the slats and bottom rail of the window blind for cutting. The first board 33 and the second board 34 are fastened together, keeping the openings 35 and 36 respectively aimed at the locating holes 37 and 38. The second board 34 has the top and bottom beveled such that a V-shaped groove 39 is respectively defined in the top and bottom sides of the cutter holder 32 (see FIG. 4).

Referring to FIG. 3 again, the first cutter 40 and the second cutter 41 each comprise a top locating block 42, a bottom locating block 43, a cutter blade 44, a pressing block 45, and a wedge block 46. The top locating block 42 and the bottom locating block 43 are respectively inserted into the V-shaped grooves 39 at the top and bottom sides of the cutter holder 32. The outer side of the top locating block 42 and the inner side of the cutter blade 44 are respectively provided with a keyway 421 for the insertion of a key 422. The cutter blade 44 is connected between the top locating block 42 and the bottom locating block 43 in vertical and supported on the outer side of the second board 34, having a cutting edge 441 facing the front side of the machine base 10. The extending direction of the cutting edge 441 defines with the vertical lateral sides of the locating holes 37 and 38 a respective contained angle such that the contact between the cutting edge 441 and the workpiece at the first time is a point contact but not a linear contact, preventing excessive resistance and achieving efficient cutting. The pressing block 45 is set in vertical, having a main body 451, a head 452, a foot 453, and a chip-guiding portion 454. The pressing block 45 is disposed at an outer side of the cutter blade 44 with the head 452 and the foot 453 respectively connected to the top locating block 42 and the bottom locating block 43, leaving the cutting edge 441 of the cutter blade 44 suspended in the space between the main body 451 and the second board 34. The main body 451 has an outwardly extended sloping face forming the chip-guiding portion 454 for guiding cut waste chips from the inner side toward the outer side. The pressing block 45 of the second cutter 41 has a coupling portion 47 near the bottom. According to this embodiment, the coupling portion 47 is a recessed hole. The wedge block 46 is set in between the respective pressing block 45 and the top locating block 42 with the sloping bottom side supported on the top side of the top locating block 42, having a transversely extended top through hole 461 and a screw bolt 462 passed through the through hole 461 and fastened to the head 452 of the respective pressing block 45. Therefore, the first cutter 40 and the second cutter 41 are slidably connected to the V-shaped grooves 39 by the top locating blocks 42 and the bottom locating blocks 43 and movable along the longitudinal axis of the cutter holder 32. Further, by means of adjusting the position of the wedge block 46 relative to the respective pressing block 45 and the top locating block 42, the tightness of the connection of the top locating block 42 to the respective V-shaped groove 39 is relatively adjusted, so that the first cutter 40 and the second cutter 41 can be slidably and closely attached to the cutter holder 32.

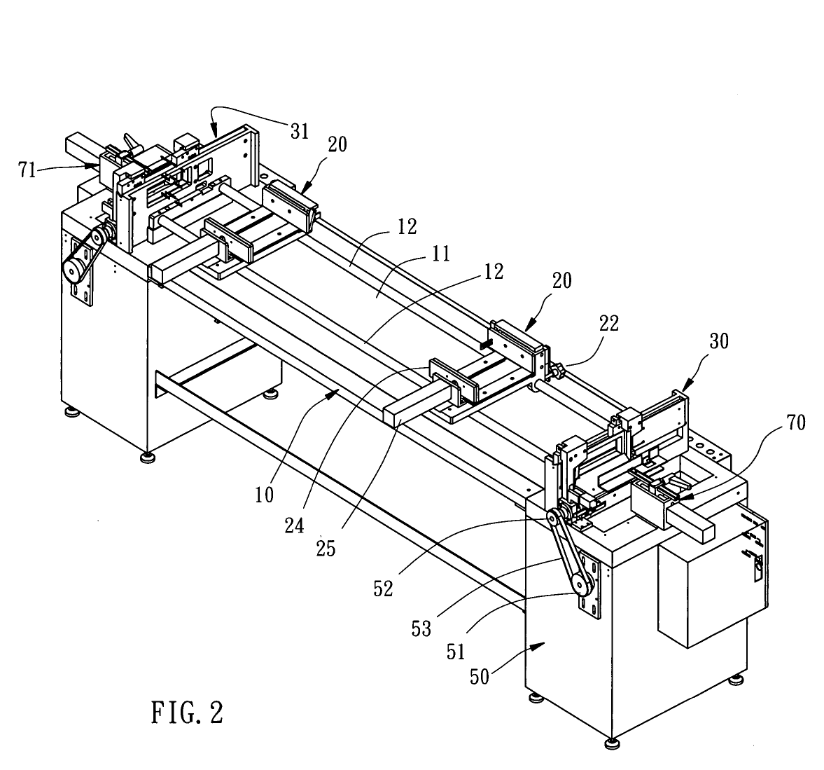

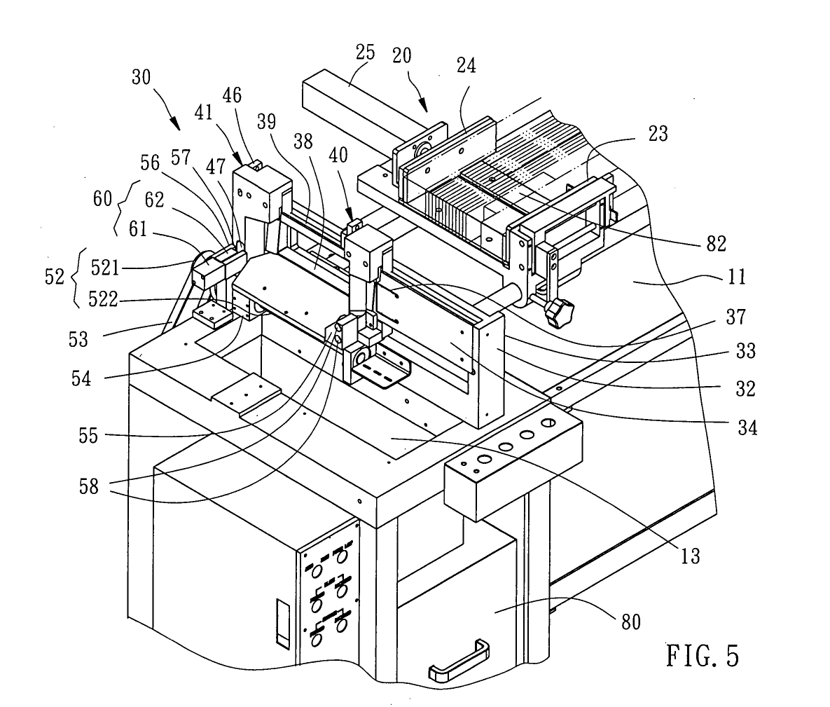

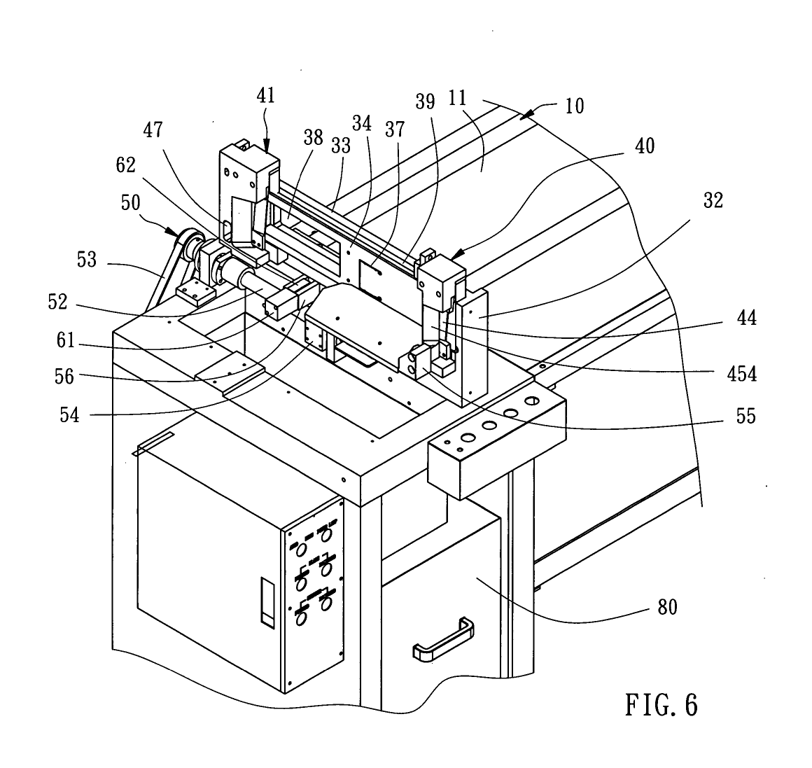

Referring to FIGS. 2 and 5, the driving mechanism 50 comprises a motor 51, a transmission device 52, a belt 53, and a slider 54. The motor 51 is provided at the back side of the cutter holder 32 near the bottom. The transmission device 52 is disposed at the outer side of the cutter holder 32, comprising a screw rod 522 arranged in parallel to the cutter holder 32 and a belt wheel 521 fixedly fastened to one end of the screw rod 522. The belt 53 is coupled between the output shaft of the motor 51 and the belt wheel 521. The slider 54 is threaded onto the screw rod 522, having an elongated first locating portion 55 disposed at one side and extending from one side of the slider 54 toward the front side of the machine base 10, a second locating portion 56 shaped like a rectangular block and disposed at the other side, and a guiding groove 57 formed in the second locating portion 56 and extended in direction perpendicular to the axis of the transmission device 52. The first locating portion 55 is fastened to the pressing block 45 of the first cutter 40 by screws 58. During rotation of the output shaft of the motor 51, the belt 53 drives the screw rod 522 of the transmission device 52 to rotate, thereby causing the slider 54 to move along the screw rod 522, and therefore the first cutter 40 is moved between an initial position (see FIG. 5) and a cut-off position (see FIG. 6). When positioned at the initial position, the first cutter 40 is disposed in between the first locating hole 37 and the second locating hole 38. When moved to the cut-off position, the first cutter 40 is moved along the board face of the cutter holder 32 to the front side of the cutter holder 32 such that the workpiece that extends out of the first locating hole 37 is cut by the cutter blade 44 of the first cutter 40.

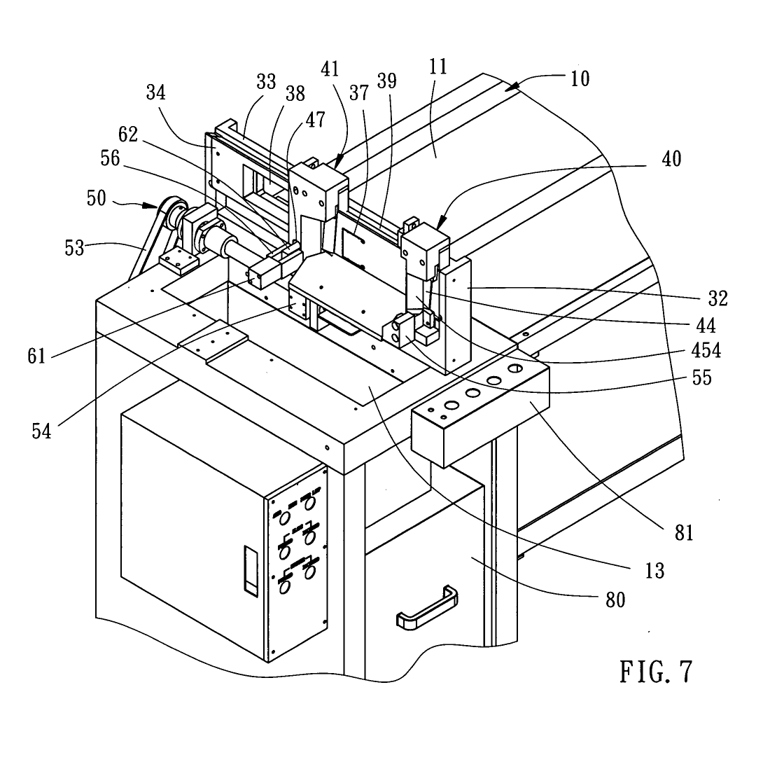

The clutch 60 comprises a pneumatic cylinder 61 and a connector 62. The connector 62 is a rectangular member connected to the distal end of the output rod of the pneumatic cylinder 61. The pneumatic cylinder 61 is disposed at an outer side of the second locating portion 56 of the slider 54, keeping the output rod suspended in the guiding groove 57 of the second locating portion 56 and adapted to move the connector 62 between a connected position (see FIG. 7) and a disconnected position (see FIG. 5). When moved to the connected position, the connector 62 engages the coupling portion 47 of the second cutter 41, and at this time the slider 54 is fixedly connected to the first cutter 40 and linked to the second cutter 41. When moved to the disconnected position, the connector 62 is disengaged from the coupling portion 47 of the second cutter 41, and at this time the slide 54 is separated from the second cutter 41 and simply fixedly connected to the first cutter 40.

Referring to FIGS. 1 and 4, the first measuring unit 70 is disposed at an outer side relative to the first cutting unit 30. The second measuring unit 71 is disposed at an outer side relative to the second cutting unit 31. Each measuring unit 70 or 71 comprises a rack 72, a scale 73, and a pneumatic cylinder 74. The rack 72 is fixedly mounted on the machine base 10. The pneumatic cylinder 74 is fixedly mounted on an outer side of the rack 72, having an output rod 79 connected to the scale 73. The scale 73 comprises a holder base 75 fixedly fastened to the distal end of the output rod 79 of the pneumatic cylinder 74 and movably mounted in the rack 72, a rule 76 provided at the top side of the holder base 75 and movable together with the holder base 75 forwards or backwards along the longitudinal axis of the machine base 10, and a locking handle 77 adapted to lock the rule 76 to the holder base 75. The rule 76 has a stop plate 78 at the outer end.

By means of the aforesaid arrangement, the window blind cutting machine can be operated to cut the headrail only, or to cut the headrail and the slat set at the same time. At first, the window blind parts are put on the clamping seats 20 in parallel to the longitudinal axis of the worktable 11, and then the first cutting unit 30 and the second cutting unit 31 are respectively operated to cut the two ends of the window blind parts.

In other words, if the user simply wishes to cut the headrail (i.e., the material of the headrail of the window blind is suitable for cutting, but the material of the slats is not suitable for cutting), the cutting operation through the first cutting unit 30 is outlined hereinafter. As shown in FIG. 5, the headrail and the slat set, as shown as imaginary lines in FIG. 5, are put on the clamping seats 20, and then a spacer block 82 is respectively placed on each clamping seat 20 between the headrail and the slat set (the width of the spacer block 82 is approximately equal to the distance between the first locating hole 37 and the second locating hole 38 such that the headrail and the slat sets can be respectively aimed at the first locating hole 37 and the second locating hole 38 for accurate cutting). In order to control the cut length of the headrail and the slat set, move the stop plate 78 of the first measuring unit 70 to a proper position subject to the indication of the rule 76 (at this time the cut size from one end of the window blind members is one half of the total length to be cut, therefore the size indicated by the rule 76 should be one half of the total length to be cut). When adjusted, operate the locking handle 77 to lock the rule 76, and then insert the headrail and the slat set through the first locating hole 37 and the second locating hole 38 and stop the headrail and the slat set against the stop plate 78, and then operate the pneumatic cylinder 25 of each clamping seat 20 to move the movable clamping plate 24 of each clamping seat 20 toward the respective fixed clamping plate 23 to hold down window blind parts, and then the pneumatic cylinder 61 of the clutch 60 is operated to move the connector 62 to the disconnected position, and then operate the pneumatic cylinder 74 of the first measuring unit 70 to move the holder base 75 and the rule 76 with the stop plate 78 backwards, and then turn on the motor 51 of the driving mechanism 50 to drive the slider 54 to carry the first cutter 40 across the first locating hole 37 to the cut-off position to cut off the portion, which extends out of the first locating hole 37, of the headrail of the window blind, as shown in FIG. 6. The waste cut materials are guided by the chip-guiding portion 454 toward the corresponding top opening 13 of the machine base 10 and the respective dust basket 80. After cutting by the first cutting unit 30, the clamping seats 20 are moved toward the second cutting unit 31, and then the aforesaid cutting procedure is repeated to cut the other end of the window blind part. After cutting of both ends of the window blind member, the clamping seats 20 are loosened, and then the well-cut window blind parts are taken away from the clamping seats 20.

If the user wishes to cut the headrail and the slat set (i.e., the materials of the headrail and slat set of the window blind are suitable for cutting), as shown in FIG. 7, control the pneumatic cylinder 61 of the clutch 60 to move the connector 62 to the connected position so as to have the slider 54 connected to the first cutter 40 and the second cutter 41. When started the motor 51 of the driving mechanism 50 at this time, the slider 54 is moved to carry the first cutter 40 to the cut-off position, and the second cutter 41 is synchronously moved with the first cutter 40 due to connection between the connector 62 and the slider 54. Therefore, the cutter blades 44 of the first and second cutters 40 and 41 are respectively moved across the first locating hole 37 and the second locating hole 38 to cut off the extending portions of the headrail and slat set. After cutting at one end of the headrail and slat set, the clamping seats 20 are moved toward the second cutting unit 31, for enabling the other end of the headrail and slat set to be properly cut.

Although a particular embodiment of the invention has been described in detail for purposes of illustration, various modifications and enhancements may be made without departing from the spirit and scope of the invention, for example, hydraulic means, electromagnetic valve means, or any of a variety of other mechanical mechanisms may be used to substitute for the pneumatic cylinder of the clutch for controlling connection of the connector to the coupling portion of the pressing block. In addition, the types, numbers and positions of the connector of the clutch and the coupling portion of the pressing block are not limited to the embodiment disclosed above. Accordingly, the invention is not to be limited except as by the appended claims.

1. A machine for cutting parts of a window blind, said machine comprising:
an elongated machine base for carrying thereon the parts of the window blind, which are parallel to and movable along a longitudinal axis of said machine base;
at least one cutting unit mounted on said machine base, said cutting unit comprising a first locating hole and a second locating hole for insertion of the parts of the window blind, a first cutter and a second cutter movable relative to said first locating hole and said second locating hole respectively, a clutch for connecting and disconnecting said second cutter to said first cutter, and a driving mechanism for driving synchronously said first cutter and said second cutter to move so as to cut off the parts of the window blind that extend out of said first locating hole and said second locating hole when said second cutter is connected to said first cutter by said clutch, and for driving said first cutter to move so as to cut off the parts of the window blind that extend out of said first locating hole when said second cutter is disconnected to said first cutter.

2. The machine as defined in claim 1, wherein said cutting unit comprises a cutter holder including a first board, which has a first opening and a second opening, and a second board, which is connected to said first board and provided with said first locating hole and said second locating hole corresponding in location to said first opening and said second opening respectively, said second board having beveled top and bottom sides respectively defined with top and bottom sides of said first board a respective V-shaped groove; wherein the first and second cutters of said cutting unit each comprise a top locating block and a bottom locating block respectively mounted in and movable along the V-shaped grooves of said cutter holder, and a cutter blade connected between said top locating block and said bottom locating block and disposed at an outer side of said second board.

3. The machine as defined in claim 2, wherein the first and second cutters of said cutting unit each further comprise a pressing block disposed at an outer side of the respective cutter blade, said pressing block having a head fastened to said top locating block, a foot fastened to said bottom locating block, and a chip-guiding portion disposed between said head and said foot corresponding to a cutting edge of the respective cutter blade.

4. The machine as claimed in claim 3, wherein said pressing block has a main body connected between said head and said foot, said main body having an outwardly extended sloping face forming said chip-guiding portion.

5. The machine as claimed in claim 3, wherein the first and second cutters of said cutting unit each further comprise a wedge block having a beveled bottom face supported on said top locating block.

6. The machine as claimed in claim 1, wherein said driving mechanism comprises a motor mounted on said machine base, a transmission device disposed at an outer side of the cutting unit, a belt coupled between an output rod of said motor and said transmission device, and a slider slidably threaded on said transmission device and provided with a first locating portion affixed to the first cutter.

7. The machine as claimed in claim 6, wherein the second cutter comprises a coupling portion; the clutch is mounted on the slider of the driving mechanism and comprises a connector and driving means for moving said connector between a connected position where said connector is connected to said coupling portion of said second cutter such that said second cutter is connected to said first cutter and a disconnected position where said connector is disconnected from said coupling portion of said second cutter such that said second cutter is disconnected to said first cutter.

8. The machine as claimed in claim 1, wherein said second cutter comprises a coupling portion; said clutch comprises a connector and driving means for moving said connector between a connected position where said connector is connected to said coupling portion of said second cutter such that said second cutter is connected to said first cutter and a disconnected position where said connector is disconnected from said coupling portion of said second cutter such that said second cutter is disconnected to said first cutter.

9. The machine as claimed in claim 1, further comprising a measuring unit disposed at an outer side of said cutting unit, said measuring unit comprising a rack, a scale, and a pneumatic cylinder, said scale comprising a holder base slidably coupled to said rack, a rule mounted on said holder base and forwardly backwardly movable on said holder base along the longitudinal axis of said machine base, and a locking handle for locking said rule to said holder base, said rule having an end disposed with a stop plate facing said cutting unit, said pneumatic cylinder being mounted on an outer side of said rack and having an output rod connected to said holder base for moving said scale along the longitudinal axis of said machine base.

10. A machine for cutting parts of a window blind, said machine comprising:
an elongated machine base for carrying thereon the parts of the window blind, which are parallel to and movable along a longitudinal axis of said machine base; and
two cutting units mounted along the longitudinal axis of said machine base on two ends of said machine base, said cutting units each comprising at least one locating hole for insertion of the parts of the window blind, at least one cutter movable relative to said locating hole, and a driving mechanism for driving said cutter to move so as to cut off the parts of the window blind that extend out of said locating hole.

11. The machine as claimed in claim 10, wherein said machine base comprises an elongated worktable, two guiding rods arranged in parallel on said worktable along the longitudinal axis of said machine base, at least one clamping seat moveably mounted on said guiding rods for carrying the parts of the window blind for cutting.

12. The machine as claimed in claim 11, wherein said clamping seat comprises a bottom coupling block moveably sleeved onto one of said guiding rods, and a lock screw threaded into said bottom coupling block and perpendicularly stoppable against the guiding rod for locking the clamping seat in position.

13. The machine as claimed in claim 10, wherein said machine base comprises two top openings respectively disposed outer sides of said cutting units, and two dust baskets respectively set below said top openings.

14. The machine as claimed in claim 11, wherein said clamping seat comprises a fixed clamping plate and a movable clamping plate movable and positionable relative to said fixed clamping plate for holding down the parts of the window blind between said fixed clamping plate and said movable clamping plate such that the parts of the window are movable along the longitudinal axis of said machine base for cutting.

15. The machine as claimed in claim 10, wherein said cutting units each comprise a plurality of said cutters and further comprise a clutch for connecting and disconnecting said cutters; wherein said driving mechanism drives said cutters to move synchronously when said cutters are connected by said clutch, and said driving mechanism drives only one of said cutters to move when said cutters are disconnected.

16. A machine for cutting parts of a window blind, said machine comprising:
an elongated machine base for carrying thereon the parts of the window blind, which are parallel to and movable along a longitudinal axis of said machine base;
at least one cutting unit mounted on said machine base, said cutting unit comprising a first locating hole and a second locating hole for insertion of the parts of the window blind, a first cutter and a second cutter movable relative to said first locating hole and said second locating hole respectively, a clutch for connecting and disconnecting said second cutter to said first cutter, and a driving mechanism for driving said first cutter to move.

17. The machine as claimed in claim 16, wherein said driving mechanism comprises a motor mounted on said machine base, a transmission device disposed at an outer side of the cutting unit, a belt coupled between an output rod of said motor and said transmission device, and a slider slidably threaded on said transmission device and provided with a first locating portion affixed to the first cutter.

18. The machine as claimed in claim 17, wherein the second cutter comprises a coupling portion; the clutch is mounted on the slider of the driving mechanism and comprises a connector and driving means for moving said connector between a connected position where said connector is connected to said coupling portion of said second cutter such that said second cutter is connected to said first cutter and a disconnected position where said connector is disconnected from said coupling portion of said second cutter such that said second cutter is disconnected to said first cutter.

19. The machine as claimed in claim 17, wherein the second cutter comprises a coupling portion; the clutch comprises a connector and driving means for moving said connector between a connected position where said connector is connected to said coupling portion of said second cutter such that said second cutter is connected to said first cutter and a disconnected position where said connector is disconnected from said coupling portion of said second cutter such that said second cutter is disconnected to said first cutter.

20. A machine for cutting parts of a window blind, said machine comprising:
an elongated machine base for carrying thereon the parts of the window blind, which are parallel to and movable along a longitudinal axis of said machine base;
at least one cutting unit mounted on said machine base, said cutting unit comprising a first locating hole and a second locating hole for insertion of the parts of the window blind, a first cutter and a second cutter movable relative to said first locating hole and said second locating hole respectively, a clutch for connecting and disconnecting said second cutter to said first cutter, and a driving mechanism having a slider movable relative to said first locating hole and said second locating hole, said slider having an end on which said first cutter is mounted and the other end on which said clutch is mounted.
